(19) United States
(12) Patent Application Publication
(10) Pub. No.: US 2006/0083953 A1
(43) Pub. Date: Apr. 20, 2006

(54) Magnetic recording medium

(75) Inventors: Yuichiro Murayama, Kanagawa (JP); Hiroshi Hashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/251,908

(22) Filed: Oct. 18, 2005

(30) Foreign Application Priority Data
Oct. 19, 2004 (JP) 2004-304152

(51) Int. Cl. G11B 5/706

(52) U.S. Cl. 428/844.8

(57) ABSTRACT

A magnetic recording medium is provided that comprises a non-magnetic support and, above the support, a radiation-cured layer cured by exposing a layer comprising a radiation curing compound to radiation, and at least one magnetic layer formed from a ferromagnetic powder dispersed in a binder, the radiation curing compound comprising a urethane (meth)acrylate obtained from a compound having two or more cyclohexane rings per molecule.

### BACKGROUND OF THE INVENTION

1. Field of the Invention

The present invention relates to a magnetic recording medium comprising a non-magnetic support and, above the support, as necessary a lower layer comprising a magnetic powder or a non-magnetic powder dispersed in a binder and, thereabove, at least one magnetic layer comprising a ferromagnetic powder dispersed in a binder.

2. Description of the Related Art

As tape-form magnetic recording media for audio, video, and computers, and disc-form magnetic recording media such as flexible discs, a magnetic recording medium has been used in which a magnetic layer having dispersed in a binder a ferromagnetic powder such as γ-iron oxide, Co-containing iron oxide, chromium oxide, or a ferromagnetic metal powder is provided on a support. With regard to the support used in the magnetic recording medium, polyethylene terephthalate (PET), polyethylene naphthalate (PEN), etc. are generally used. Since these supports are drawn and are highly crystallized, their mechanical strength is high and their solvent resistance is excellent.

The magnetic layer, which is obtained by coating the support with a coating solution having the ferromagnetic powder dispersed in the binder, has a high degree of packing of the ferromagnetic powder, low elongation at break, and is brittle, and it is therefore easily destroyed by the application of mechanical force and might peel off from the support. In order to prevent this, an undercoat layer is provided on the support so as to make the magnetic layer adhere strongly to the support.

On the other hand, magnetic recording media are known in which a radiation-cured layer is formed using a compound having a functional group that is cured by radiation such as an electron beam, that is, a radiation curing compound.

There have been proposed, for example, a magnetic recording medium formed by providing a middle layer comprising a polyurethane having two or more acryloyl groups or methacryloyl groups per molecule and exposing the middle layer to radiation (ref. JP-A-60-133531; JP-A denotes a Japanese unexamined patent application publication), and a magnetic recording medium whose undercoat layer and magnetic layer comprise a radiation curing compound, the radiation curing compound of the magnetic layer being a radiation curing type monomer or oligomer having a functional group that is polymerizable by radiation (ref. JP-A-2001-084582). However, these magnetic recording media do not have adequate coating smoothness or strength.

Furthermore, a magnetic recording medium having an undercoat layer formed from a compound having an alicyclic ring structure and two or more radiation curing functional groups per molecule has been proposed (ref. JP-A-2003-141713), but the adhesion is not sufficient, and the durability might be degraded.

Moreover, a magnetic recording medium having an undercoat layer formed by radiation curing a compound having a cyclic ether framework and two or more radiation curing functional groups per molecule or a compound having a cyclic structure, an ether group, and two or more radiation curing functional groups per molecule (excluding an aromatic compound having an ester bond) has been proposed (ref. JP-A-2004-111001), but there have been occasions where storage stability/durability failure has occurred in a high temperature environment.

### BRIEF SUMMARY OF THE INVENTION

It is an object of the present invention to provide a magnetic recording medium that has excellent long-term storage stability, electromagnetic conversion characteristics, and transport durability.

The object of the present invention has been attained by the magnetic recording media of (1) to (3).

(1) A magnetic recording medium comprising a non-magnetic support and, above the support, a radiation-cured layer cured by exposing a layer comprising a radiation curing compound to radiation, and at least one magnetic layer comprising a ferromagnetic powder dispersed in a binder, the radiation curing compound comprising a urethane (meth)acrylate obtained from a compound having two or more cyclohexane rings per molecule,

(2) the magnetic recording medium according to (1), wherein the magnetic recording medium comprises, between the radiation-cured layer and the magnetic layer, a non-magnetic layer comprising a non-magnetic powder dispersed in a binder, and

(3) the magnetic recording medium according to (1) or (2), wherein the compound having two or more cyclohexane rings per molecule is a hydrogenated diphenylmethane diisocyanate.

### BEST MODE FOR CARRYING OUT THE INVENTION

The magnetic recording medium of the present invention comprises as a radiation curing compound a urethane (meth)acrylate obtained from a compound having two or more cyclohexane rings (hereinafter, also called a ‘cyclohexane ring-containing urethane (meth)acrylate’).

The compound having two or more cyclohexane rings is mainly used as a diol or diisocyanate component constituting a urethane.

Since the radiation curing compound used in the present invention has a cyclohexane ring, the coating strength is high and the durability is excellent. It is surmised that, since the cyclohexane ring is relatively hydrophobic and can suppress moisture absorption during long-term storage in a high humidity environment and make hydrolysis of an acryloyl group, etc. difficult, there is an effect of preventing the durability of a coating from deteriorating. There is also an effect of suppressing expansion of the coating due to moisture absorption. In particular, in digital recording tapes for computer use, there is little occurrence of errors due to displacement of record/playback tracks caused by a change in width.

If the same level of cyclohexane rings as in the present invention were to be incorporated using a urethane (meth)acrylate formed from a compound having one cyclohexane ring per molecule, since the urethane group concentration would inevitably increase, the entire radiation-cured layer would become hydrophilic, and the effect of preventing moisture absorption, etc. would be reduced, but this can be improved by using as a radiation curing compound a urethane (meth)acrylate obtained from a compound having two or more cyclohexane rings per molecule.

Furthermore, the urethane (meth)acrylate used in the present invention has excellent adhesion to supports such as PEN, PET, or aramid, which are generally known to be used as supports for magnetic tape. It is surmised that this is due to the cyclohexane ring having a high affinity for the surface of the support.

Furthermore, the compound used in the present invention has a cyclic structure, but the curability is excellent. It is surmised that, since there are two cyclohexane rings, the molecule is bent appropriately, and there is little restraint of molecular movement during curing.

By providing on a support a radiation-cured layer that uses a urethane (meth)acrylate obtained from a compound having two or more cyclohexane rings per molecule, projections on the support can be buried, a magnetic recording medium having excellent smoothness can be obtained, and high electromagnetic conversion characteristics can also be obtained.

The compound having two or more cyclohexane rings per molecule is preferably a compound having a dicyclohexylmethane, hydrogenated biphenyl, etc. framework such as those represented by the formulae below.

The urethane (meth)acrylate used in the present invention can be obtained by reacting a diisocyanate compound, a diol compound, a urethane oligomer having a terminal isocyanate group (hereinafter, also called a ‘terminal NCO urethane oligomer’), or a urethane oligomer having a terminal hydroxyl group (hereinafter, also called a ‘terminal OH urethane oligomer’) having these frameworks, with a compound having both a radiation curing functional group and a group that reacts with an NCO group or an OH group.

Examples of the framework having two or more cyclohexane rings are listed below.

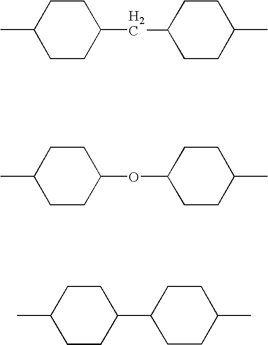

The number of cyclohexane rings of the compound having two or more cyclohexane rings per molecule is preferably 2 to 5, and more preferably 2. If the number of cyclohexane rings per molecule is within the above-mentioned range, the curability is good.

Examples of the diisocyanate compound having two or more cyclohexane rings per molecule include hydrogenated diphenylmethane diisocyanate, hydrogenated biphenyl diisocyanate, and hydrogenated biphenyl ether diisocyanate. Among them, hydrogenated diphenylmethane diisocyanate is preferable.

Examples of the diol compound having two or more cyclohexane rings per molecule include hydrogenated bisphenol A, hydrogenated biphenol, hydrogenated biphenyl ether diol, or an ethylene oxide or propylene oxide adduct thereof.

The terminal NCO urethane oligomer or terminal OH urethane oligomer having two or more cyclohexane rings per molecule can be obtained by adjusting the reaction ratio of the OH group and the NCO group using the above-mentioned diisocyanate compound and diol compound.

When the urethane oligomer is synthesized, at least one of the diisocyanate component and the diol component may be a compound having two or more cyclohexane rings per molecule, and a diisocyanate component or a diol component that does not have two or more cyclohexane rings per molecule may be used in combination.

The diisocyanate component that can be used in combination may be a known compound. Examples thereof include hexamethylene diisocyanate, tolylene diisocyanate, diphenylmethane diisocyanate, hydrogenated diphenylmethane diisocyanate, p-phenylene diisocyanate, o-phenylene diisocyanate, m-phenylene diisocyanate, xylylene diisocyanate, hydrogenated xylylene diisocyanate, isophorone diisocyanate, and naphthalene diisocyanate. The diisocyanate component that can be used in combination is preferably one that has no benzene ring.

The diol component that can be used in combination may be a known compound. Examples thereof include aliphatic straight-chain diols such as 1,3-propanediol, 1,4-butanediol, 1,5-pentanediol, and 1,6-hexanediol; aliphatic diols having a branched side chain such as 2,2-dimethyl-1,3-propanediol, 3,3-dimethyl-1,5-pentanediol, 2-methyl-2-ethyl-1,3-propanediol, 3-methyl-3-ethyl-1,5-pentanediol, 2-methyl-2-propyl-1,3-propanediol, 3-methyl-3-propyl-1,5-pentanediol, 2-methyl-2-butyl-1,3-propanediol, 3-methyl-3-butyl-1,5-pentanediol, 2,2-diethyl-1,3-propanediol, 3,3-diethyl-1,5-pentanediol, 2-ethyl-2-butyl-1,3-propanediol, 3-ethyl-3-butyl-1,5-pentanediol, 2-ethyl-2-propyl-1,3-propanediol, 3-ethyl-3-propyl-1,5-pentanediol, 2,2-dibutyl-1,3-propanediol, 3,3-dibutyl-1,5-pentanediol, 2,2-dipropyl-1,3-propanediol, 3,3-dipropyl-1,5-pentanediol, 2-butyl-2-propyl-1,3-propanediol, 3-butyl-3-propyl-1,5-pentanediol, 2-ethyl-1,3-propanediol, 2-propyl-1,3-propanediol, 2-butyl-1,3-propanediol, 3-ethyl-1,5-pentanediol, 3-propyl-1,5-pentanediol, 3-butyl-1,5-pentanediol, 3-octyl-1,5-pentanediol, 3-myristyl-1,5-pentanediol, 3-stearyl-1,5-pentanediol, 2-ethyl-1,6-hexanediol, 2-propyl-1,6-hexanediol, 2-butyl-1,6-hexanediol, 5-ethyl-1,9-nonanediol, 5-propyl-1,9-nonanediol, and 5-butyl-1,9-nonanediol; and diols having a cyclic structure such as bisphenol A, tricyclo[2.2. 1.0]heptanedimethanol, tricyclo[5.2.1.0^{2,6}]decanedimethanol, bicyclo[3.3.2]decanedimethanol, bicyclo[4.2.2]decanedimethanol, spiro[3,4]decanedimethanol, and bis(1,1-dimethyl-2-hydroxyethyl)-2,4,8,10-tetraoxaspiro[5,5]undecane.

The diol component that can be used in combination is preferably one that has no benzene ring.

The urethane (meth)acrylate can be obtained by reacting the above-mentioned diisocyanate compound, diol compound, terminal NCO urethane oligomer, or terminal OH urethane oligomer having two or more cyclohexane rings per molecule with a compound having both a radiation curing functional group and a group that can react with an NCO group or an OH group.

Examples of the radiation curing functional group include an acryloyl group and a methacryloyl group, and an acryloyl group is preferable.

Examples of the compound having both a radiation curing functional group and a group that can react with an NCO group or an OH group include hydroxyethyl acrylate, hydroxyethyl methacrylate, acryloyloxyethyl isocyanate, methacryloyloxyethyl acrylate, caprolactone-modified ethyl acrylate, caprolactone-modified ethyl methacrylate, pentaerythritol triacrylate, trimethylolpropane diacrylate, dipentaerythritol pentaacrylate, pentaerythritol trimethacrylate, trimethylolpropane dimethacrylate, and dipentaerythritol pentamethacrylate.

Among them, those having an acrylate group are preferable, and hydroxyethyl acrylate and acryloyloxyethyl isocyanate are particularly preferable.

The molecular weight of the cyclohexane ring-containing urethane (meth)acrylate is preferably 400 to 3,000, and more preferably 400 to 1,500. If the molecular weight is in this range, the viscosity becomes appropriate and the smoothness is good.

The number of radiation curing functional groups of the urethane (meth)acrylate is preferably 2 to 10 per molecule, and more preferably 2 to 6. If the number of radiation curing functional groups is in this range, sufficient curability can be obtained, and since curing shrinkage is reduced, the smoothness of the coating is good.

The viscosity of the urethane (meth)acrylate at 25° C. is preferably 100 to 20,000 mPa·s (cps), and more preferably 100 to 10,000 mPa·s (cps). If the viscosity is in this range, the smoothness is good.

The radiation-cured layer may be formed, in addition to the cyclohexane ring-containing urethane (meth)acrylate, from a known radiation curing compound in combination as necessary.

As the radiation curing compound used in combination, one having two or more acryloyl groups is preferable.

Preferred examples of the compound used in combination include those having a cyclic structure such as 5-ethyl-2-(2-hydroxy-1, 1′-dimethylethyl)-5-(hydroxymethyl)-1,3-dioxane diacrylate, tetrahydrofurandimethanol diacrylate, 3,9-bis(1,1-dimethyl-2-hydroxyethyl)-2,4,8,10-tetraoxaspiro(5.5)undecane diacrylate, and tricyclodecanedimethanol diacrylate.

In this case, it is preferable for the urethane (meth)acrylate obtained from the compound having two or more cyclohexane groups of the present invention to constitute at least 50 wt % of the entire radiation-cured layer. When the content is equal to or greater than 50 wt %, sufficient effects can be exhibited.

The thickness of the radiation-cured layer is preferably 0.1 to 1.0 μm. If the thickness of the radiation-cured layer is in this range, sufficient smoothness can be obtained and adhesion to a support is good.

The glass transition temperature (Tg) of the radiation-cured layer is preferably 50° C. to 150° C., and more preferably 80° C. to 130° C. If Tg is in this range, there are few problems with tackiness during a coating step and high coating strength can be obtained.

The modulus of elasticity of the radiation-cured layer is preferably 1.5 to 4 GPa. If the modulus of elasticity is in this range, there are few problems with tackiness of a coating and a desirable coating strength can be obtained.

The average surface roughness (Ra) of the radiation-cured layer is preferably 1 to 2 nm. If the average surface roughness (Ra) is in this range since there are few problems with sticking to a path roller during a coating step, and the magnetic layer has sufficient smoothness.

With regard to the support that is used in the magnetic recording medium of the present invention, known biaxially drawn films such as polyethylene terephthalate, polyethylene naphthalate, polyamide, polyamideimide, and aromatic polyamide can be used. Polyethylene terephthalate, polyethylene naphthalate, and polyamide are preferable. These supports can be subjected in advance to a corona discharge treatment, a plasma treatment, a treatment for enhancing adhesion, a thermal treatment, etc. The support preferably has a surface roughness (Ra) of 3 to 10 nm for a cutoff value of 0.25 mm.

The radiation-cured layer is formed by applying to the support and drying and then exposing to radiation so as to cure the compound.

The radiation used in the present invention may be an electron beam or ultraviolet rays. When ultraviolet rays are used, it is necessary to add a photopolymerization initiator to the compound. In the case of curing with an electron beam, no polymerization initiator is required, and in addition the electron beam has a deep penetration depth, which is preferable.

With regard to electron beam accelerators that can be used here, there are a scanning system, a double scanning system, and a curtain beam system, and the curtain beam system is preferable since it is relatively inexpensive and gives a high output. With regard to electron beam characteristics, the acceleration voltage is preferably 30 to 1,000 kV, and more preferably 50 to 300 kV. The absorbed dose is preferably 0.5 to 20 Mrad, and more preferably 2 to 10 Mrad. It is preferable if the acceleration voltage is at least 30 kV since the amount of energy penetrating is sufficient, and if it is not more than 1,000 kV since good energy efficiency is obtained for polymerization, which is economical.

The electron beam irradiation atmosphere is preferably controlled by a nitrogen purge so that the concentration of oxygen is 200 ppm or less. It is preferable if the concentration of oxygen is low since crosslinking and curing reactions in the vicinity of the surface are not inhibited.

As a light source for the ultraviolet rays, a mercury lamp may be used. The mercury lamp is, for example, a 20 to 240 W/cm lamp and is used at a speed of 0.3 to 20 m/min. The distance between a substrate and the mercury lamp is generally preferably 1 to 30 cm.

As the photopolymerization initiator used for ultraviolet curing, a radical photopolymerization initiator may be used. More particularly, those described in, for example, ‘Shinkobunshi Jikkengaku’ (New Polymer Experiments), Vol. 2, Chapter 6 Photo/Radiation Polymerization (Published by Kyoritsu Publishing, 1995, Ed. by the Society of Polymer Science, Japan) can be used. Specific examples thereof include acetophenone, benzophenone, anthraquinone, benzoin ethyl ether, benzil methyl ketal, benzil ethyl ketal, benzoin isobutyl ketone, hydroxydimethyl phenyl ketone, 1-hydroxycyclohexyl phenyl ketone, and 2,2-diethoxyacetophenone. The mixing ratio of the aromatic ketone is preferably 0.5 to 20 parts by weight relative to 100 parts by weight of the radiation curing compound, more preferably 2 to 15 parts by weight, and yet more preferably 3 to 10 parts by weight.

With regard to radiation-curing equipment, conditions, etc., known equipment and conditions described in ‘UV.EB Kokagijutsu’ (UV/EB Radiation Curing Technology) (published by Sogo Gijutsu Center), ‘Teienerugi Denshisenshosha no Oyogijutsu’ (Applied Technology of Low-energy Electron Beam) (2000, Published by CMC), etc. can be employed.

The magnetic recording medium of the present invention preferably has a coefficient of hygroscopic expansion of 0 to 15 ppm/% RH, and more preferably 0 to 10 ppm/% RH.

The coefficient of hygroscopic expansion referred to here can be determined by the equation below.

$$Coefficient of hygroscopic expansion = \frac{\frac{length of magnetic recording medium at {T}_{4} - length of magnetic recording medium at {T}_{3}}{length of magnetic recording medium at {T}_{3}}}{change in humidity ( {T}_{4} - {T}_{3} )} \qquad ( Eq . 2 )$$

In the equation, T₃ denotes the % RH at the beginning of the measurement and T₄ denotes the % RH at the end of the measurement.

The humidity for the coefficient of hygroscopic expansion can be determined freely according to the measurement conditions. For example, the coefficient of hygroscopic expansion can be determined by measuring the change in dimensions of the magnetic recording medium for a change in humidity between 30% RH and 80% RH.

The magnetic recording medium of the present invention can be prepared by forming the above-mentioned radiation-cured layer, subsequently forming a non-magnetic lower layer or a magnetic lower layer on the radiation-cured layer, and then forming a magnetic layer, or alternatively by forming a magnetic layer directly on the radiation-cured layer. The radiation-cured layer may be provided on one side of a support or both sides thereof. The non-magnetic layer, the magnetic lower layer, or the magnetic layer may be formed by coating with a composition comprising a non-magnetic powder or a magnetic powder dispersed in a binder.

Examples of the binder include a polyurethane resin, a polyester resin, a polyamide resin, a vinyl chloride resin, an acrylic resin obtained by copolymerization of styrene, acrylonitrile, methyl methacrylate, etc., a cellulose resin such as nitrocellulose, an epoxy resin, a phenoxy resin, and a polyvinyl alkyral resin such as polyvinyl acetal or polyvinyl butyral, and they can be used singly or in a combination of two or more types. Among these, the polyurethane resin, the vinyl chloride resin, and the acrylic resin are preferable.

In order to improve the dispersibility of the magnetic powder and the non-magnetic powder, the binder preferably has a functional group (polar group) that is adsorbed on the surface of the powders. Preferred examples of the functional group include —SO₃M, —SO₄M, —PO(OM)₂, —OPO(OM)₂, —COOM, R¹R²NSO₃M, R¹R²NRSO₃M, —NR¹R², and —N⁺R¹R²R³X⁻. M denotes a hydrogen atom or an alkali metal such as Na or K, R denotes an alkylene group, R¹, R², and R³ denote alkyl groups, hydroxyalkyl groups, or hydrogen atoms, R¹ and R² may together form a ring, and X denotes a halogen such as Cl or Br. The amount of functional group in the binder is preferably 10 to 200 μeq/g, and more preferably 30 to 120 μeq/g. It is preferable if it is in this range since good dispersibility can be achieved.

The binder preferably includes, in addition to the adsorbing functional group, a functional group having an active hydrogen, such as an —OH group, in order to improve the coating strength by reacting with an isocyanate curing agent so as to form a crosslinked structure. A preferred amount is 0.1 to 2 meq/g. The molecular weight of the binder is preferably 10,000 to 200,000 as a weight-average molecular weight, and more preferably 20,000 to 100,000. It is preferable if the weight-average molecular weight is at least 10,000 since the coating strength is high and the durability is good, and if it is not more than 200,000 since the dispersibility is good.

The polyurethane resin, which is a preferred binder, is described in detail in, for example, ‘Poriuretan Jushi Handobukku’ (Polyurethane Resin Handbook) (Ed., K. Iwata, 1986, The Nikkan Kogyo Shimbun, Ltd.), and it may normally be obtained by addition-polymerization of a long chain diol, a short chain diol (also known as a chain extending agent), and a diisocyanate compound. As the long chain diol, a polyester diol, a polyether diol, a polyetherester diol, a polycarbonate diol, a polyolefin diol, etc, having a molecular weight of 500 to 5,000 may be used. Depending on the type of this long chain polyol, the polyurethane is called a polyester urethane, a polyether urethane, a polyetherester urethane, a polycarbonate urethane, etc.

The polyester diol may be obtained by a condensation-polymerization between a glycol and a dibasic aliphatic acid such as adipic acid, sebacic acid, or azelaic acid, or a dibasic aromatic acid such as isophthalic acid, orthophthalic acid, terephthalic acid, or naphthalenedicarboxylic acid. Examples of the glycol component include ethylene glycol, 1,2-propylene glycol, 1,3-propanediol, 1,4-butanediol, 1,5-pentanediol, 3-methyl-1,5-pentanediol, 1,6-hexanediol, 2,2-dimethyl-1,3-propanediol, 1,8-octanediol, 1,9-nonanediol, cyclohexanediol, cyclohexanedimethanol, and hydrogenated bisphenol A. As the polyester diol, in addition to the above, a polycaprolactonediol or a polyvalerolactonediol obtained by ring-opening polymerization of a lactone such as ε-caprolactone or γ-valerolactone can be used. From the viewpoint of resistance to hydrolysis, the polyester diol is preferably one having a branched side chain or one obtained from an aromatic or alicyclic starting material.

Examples of the polyether diol include polyethylene glycol, polypropylene glycol, polytetramethylene glycol, aromatic glycols such as bisphenol A, bisphenol S, bisphenol P, and hydrogenated bisphenol A, and addition-polymerization products from an alicyclic diol and an alkylene oxide such as ethylene oxide or propylene oxide.

These long chain diols can be used as a mixture of a plurality of types thereof. The short chain diol can be chosen from the compound. group that is cited as the glycol component of the above-mentioned polyester diol. Furthermore, a small amount of a tri- or higher-hydric alcohol such as, for example, trimethylolethane, trimethylolpropane, or pentaerythritol can be added, and this gives a polyurethane resin having a branched structure, thus reducing the solution viscosity and increasing the number of OH end groups of the polyurethane so as to improve the curability with the isocyanate curing agent.

Examples of the diisocyanate compound include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), p-phenylene diisocyanate, and XDI (xylylene diisocyanate), and aliphatic and alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

The long chain diol/short chain diol/diisocyanate ratio in the polyurethane resin is preferably (80 to 15 wt %)/(5 to 40 wt %)/(15 to 50 wt %). The concentration of urethane groups in the polyurethane resin is preferably 1 to 5 meq/g, and more preferably 1.5 to 4.5 meq/g. If the concentration of urethane groups is at least 1 meq/g, the mechanical strength is high, and if it is not more than 5 meq/g, the solution viscosity is low and the dispersibility is good. The glass transition temperature of the polyurethane resin is preferably 0° C. to 200° C., and more preferably 40° C. to 160° C. It is preferable if it is at least 0° C. since the durability is high and if it is not more than 200° C. since the calender moldability is good and the electromagnetic conversion characteristics improve. With regard to a method for introducing the adsorbing functional group (polar group) into the polyurethane resin, there are, for example, a method in which the functional group is used in a part of the long chain diol monomer, a method in which it is used in a part of the short chain diol, and a method in which, after the polyurethane is formed by polymerization, the polar group is introduced by a polymer reaction.

As the vinyl chloride resin, a copolymer of a vinyl chloride monomer and various types of monomer may be used. Examples of the comonomer include fatty acid vinyl esters such as vinyl acetate and vinyl propionate, acrylates and methacrylates such as methyl (meth)acrylate, ethyl (meth)acrylate, isopropyl (meth)acrylate, butyl (meth)acrylate, and benzyl (meth)acrylate, alkyl allyl ethers such as allyl methyl ether, allyl ethyl ether, allyl propyl ether, and allyl butyl ether, and others such as styrene, α-methylstyrene, vinylidene chloride, acrylonitrile, ethylene, butadiene, and acrylamide; examples of a comonomer having a functional group include vinyl alcohol, 2-hydroxyethyl (meth)acrylate, polyethylene glycol (meth)acrylate, 2-hydroxypropyl (meth)acrylate, 3-hydroxypropyl (meth)acrylate, polypropylene glycol (meth)acrylate, 2-hydroxyethyl allyl ether, 2-hydroxypropyl allyl ether, 3-hydroxypropyl allyl ether, p-vinylphenol, maleic acid, maleic anhydride, acrylic acid, methacrylic acid, glycidyl (meth)acrylate, allyl glycidyl ether, phosphoethyl (meth)acrylate, sulfoethyl (meth)acrylate, p-styrenesulfonic acid, and Na salts and K salts thereof. Here, (meth)acrylate means one that includes at least one of acrylate and methacrylate.

The proportion of the vinyl chloride monomer in the vinyl chloride resin is preferably 60 to 95 wt %. If it is at least 60 wt %, the mechanical strength improves, and if it is not more than 95 wt %, the solvent solubility is high, the solution viscosity is low, and as a result the dispersibility is good. A preferred amount of a functional group for improving the curability of the adsorbing functional group (polar group) with a polyisocyanate curing agent is as described above. With regard to a method for introducing these functional groups, a monomer containing the above-mentioned functional group can be copolymerized, or after the vinyl chloride resin is formed by copolymerization, the functional group can be introduced by a polymer reaction. A preferred degree of polymerization is 200 to 600, and more preferably 240 to 450. If the degree of polymerization is at least 200 the mechanical strength is high, and if it is not more than 600 the solution viscosity is low, and as a result the dispersibility is high.

In the present invention, in order to increase the mechanical strength and heat resistance of a coating by crosslinking and curing the binder, it is possible to use a curing agent. A preferred curing agent is a polyisocyanate compound. The polyisocyanate compound is preferably a tri- or higher-functional polyisocyanate. Specific examples thereof include adduct type polyisocyanate compounds such as a compound in which 3 moles of TDI (tolylene diisocyanate) are added to 1 mole of trimethylolpropane (TMP), a compound in which 3 moles of HDI (hexamethylene diisocyanate) are added to 1 mole of TMP, a compound in which 3 moles of IPDI (isophorone diisocyanate) are added to 1 mole of TMP, and a compound in which 3 moles of XDI (xylylene diisocyanate) are added to 1 mole of TMP, a condensed isocyanurate type trimer of TDI, a condensed isocyanurate type pentamer of TDI, a condensed isocyanurate heptamer of TDI, mixtures thereof, an isocyanurate type condensation product of HDI, an isocyanurate type condensation product of IPDI, and crude MDI. Among these, the compound in which 3 moles of TDI are added to 1 mole of TMP, and the isocyanurate type trimer of TDI are preferable.

Other than the isocyanate curing agents, a radiation curing agent that cures when exposed to an electron beam, ultraviolet rays, etc. can be used. In this case, it is possible to use a curing agent having, as radiation curing functional groups, two or more, and preferably three or more, acryloyl or methacryloyl groups per molecule. Examples thereof include TMP (trimethylolpropane) triacrylate, pentaerythritol tetraacrylate, and a urethane acrylate oligomer. In this case, it is preferable to introduce a (meth)acryloyl group not only into the curing agent but also into the binder. In the case of curing with ultraviolet rays, a photosensitizer is additionally used. It is preferable to add 0 to 80 parts by weight of the curing agent relative to 100 parts by weight of the binder. When the curing agent is in this range, the dispersibility is good.

As the ferromagnetic powder used in the magnetic recording medium of the present invention, ferromagnetic iron oxide, cobalt-containing ferromagnetic iron oxide, or a ferromagnetic alloy powder may be used. The specific surface area by the BET method (S_{BET}) is preferably 40 to 80 m²/g, and more preferably 50 to 70 m²/g. The crystallite size is usually preferably 12 to 25 nm, more preferably 13 to 22 nm, and particularly preferably 14 to 20 nm. The major axis length is preferably 0.02 to 0.25 μm, more preferably 0.025 to 0.2 μm, and particularly preferably 0.03 to 0.15 μm. Examples of the ferromagnetic metal powder include Fe, Ni, Fe—Co, Fe—Ni, and Co—Ni—Fe, and it is also possible to use an alloy containing, at up to 20 wt % of the metal component, aluminum, silicon, sulfur, scandium, titanium, vanadium, chromium, manganese, copper, zinc, yttrium, molybdenum, rhodium, palladium, gold, tin, antimony, boron, barium, tantalum, tungsten, rhenium, silver, lead, phosphorus, lanthanum, cerium, praseodymium, neodymium, tellurium, or bismuth. It is also possible for the ferromagnetic metal powder to contain a small amount of water, a hydroxide, or an oxide. The method for preparing these ferromagnetic powders is already known, and the ferromagnetic powder used in the present invention can be produced according to the known method. The shape of the ferromagnetic powder is not particularly limited and, for example, an acicular, granular, cuboidal, rice-grain shaped, or tabular powder is usually used. The use of an acicular ferromagnetic powder is particularly preferable.

The above-mentioned resin component, curing agent, and ferromagnetic powder are kneaded with and dispersed in a solvent such as methyl ethyl ketone, dioxane, cyclohexanone, or ethyl acetate, which are normally used for the preparation of a magnetic layer coating solution, to give a magnetic coating solution. The kneading and dispersing can be carried out by a standard method. The magnetic recording medium of the present invention may include a non-magnetic lower coated layer or a magnetic lower coated layer comprising a non-magnetic powder or a magnetic powder. The non-magnetic powder can be selected from an inorganic compound such as a metal oxide, a metal carbonate, a metal sulfate, a metal nitride, a metal carbide, and a metal sulfide. As the inorganic compound, α-alumina with an α-component proportion of 90% to 100%, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium oxide, calcium sulfate, barium sulfate, molybdenum disulfide, etc. can be used singly or in combination. Titanium dioxide, zinc oxide, iron oxide, and barium sulfate are particularly preferable, and titanium dioxide and iron oxide are more preferable. The average.p.article size of such a non-magnetic powder is preferably 0.005 to 2 μm, but it is also possible, as necessary, to combine non-magnetic powders having different particle sizes or widen the particle size distribution of a single non-magnetic powder, thus producing the same effect. The average particle size of the non-magnetic powder is particularly preferably 0.01 to 0.2 μm. The pH of the non-magnetic powder is particularly preferably in the range of 6 to 9. The specific surface area of the non-magnetic powder is usually 1 to 100 m²/g, preferably 5 to 70 m²/g, and more preferably 7 to 60 m²/g. The crystallite size of the non-magnetic powder is preferably 0.01 to 2 μm. The oil absorption measured using DBP is usually 5 to 100 mL/100 g, preferably 10 to 80 mL/100 g, and more preferably 20 to 60 mL/100 g. The specific gravity is preferably 1 to 12, and more preferably 3 to 6. The form may be any one of acicular, spherical, polyhedral, and tabular.

The surface of the non-magnetic powder is preferably subjected to a surface treatment so that Al₂O₃, SiO₂, TiO₂, ZrO₂, SnO₂, Sb₂O₃, or ZnO is present thereon. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a co-precipitated surface-treated layer may be used, or a method can be employed in which alumina is firstly used for treatment and the surface thereof is then treated with silica, or vice versa. The surface-treated layer may be formed as a porous layer depending on the intended purpose, but it is generally preferable for it to be uniform and dense.

As the magnetic powder that can be used in the lower coated layer, γ-Fe₂O₃, Co-modified γ-Fe₂O₃, an alloy having α-Fe as the main component, CrO₂, etc. can be used. In particular, Co-modified γ-Fe₂O₃ is preferable. The ferromagnetic powder used in the lower layer preferably has a different composition and performance from those of the ferromagnetic powder used in the upper magnetic layer. For example, in order to improve long wavelength recording properties, the coercive force (Hc) of the lower magnetic layer is desirably set so as to be lower than that of the upper magnetic layer, and it is effective to set the residual magnetic flux density (Br) of the lower magnetic layer so as to be higher than that of the upper magnetic layer. In addition to the above, it is also possible to impart advantages arising from the employment of a known multilayer structure.

As an additive that is used in the magnetic layer and the lower coated layer in the present invention, one having a lubricating effect, an antistatic effect, a dispersing effect, a plasticizing effect, etc. may be used. Examples thereof include molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, an alkyl phosphate and an alkali metal salt thereof, an alkyl sulfate and an alkali metal salt thereof, a polyphenyl ether, a fluorine-containing alkyl sulfate and an alkali metal salt thereof, a monobasic fatty acid having 10 to 24 carbons (which may contain an unsaturated bond and may be branched) and a metal salt thereof (with Li, Na, K, Cu, etc.), a mono-, di-, tri-, tetra-, penta- or hexa-hydric alcohol having 12 to 22 carbons (which may contain an unsaturated bond and may be branched), an alkoxy alcohol having 12 to 22 carbons (which may contain an unsaturated bond and may be branched), a mono-, di- or tri-fatty acid ester formed from a monobasic fatty acid having 10 to 24 carbons (which may contain an unsaturated bond and may be branched) and any one of mono-, di-, tri-, tetra-, penta- and hexa-hydric alcohols having 2 to 12 carbons (which may contain an unsaturated bond and may be branched), a fatty acid ester of a monoalkyl ether of an alkylene oxide polymer, a fatty acid amide having 2 to 22 carbons, and an aliphatic amine having 8 to 22 carbons. Specific examples thereof include lauric acid, myristic acid, palmitic acid, stearic acid, behenic acid, butyl stearate, oleic acid, linoleic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol, and lauryl alcohol.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid, a phosphoric acid, a sulfate ester group, or a phosphate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing). These lubricants, antistatic agents, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

The type and the amount of the lubricant and surfactant used in the present invention can be changed as necessary in the non-magnetic layer and the magnetic layer. For example, their exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer, but the present invention should not be construed as being limited only to the examples illustrated here. All or a part of the additives used in the present invention may be added to a magnetic layer coating solution or a lower layer coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

Specific examples of these lubricants used in the present invention include NAA-102, hardened castor oil fatty acid, NAA-42, Cation SA, Nymeen L-201, Nonion E-208, Anon BF, Anon LG, butyl stearate, butyl laurate, and erucic acid (produced by Nippon Oil & Fats Co., Ltd.); oleic acid (produced by Kanto Kagaku); FAL-205, and FAL-123 (produced by Takemoto Oil & Fat Co., Ltd), Enujelv OL (produced by New Japan Chemical Co., Ltd.), TA-3 (produced by Shin-Etsu Chemical Industry Co., Ltd.), Armide P (produced by Lion Armour), Duomin TDO (produced by Lion Corporation), BA-41G (produced by The Nisshin Oil Mills, Ltd.), and Profan 2012E, Newpol PE 61, and lonet MS-400 (produced by Sanyo Chemical Industries, Ltd.).

By coating the surface of the radiation-cured layer on the support with a coating solution prepared using the above-mentioned materials, a lower coated layer or a magnetic layer can be formed. The method for producing the magnetic recording medium of the present invention involves, for example, coating the surface of the radiation-cured layer on the support, while it is running, with a magnetic layer coating solution so as to give a dry thickness of the magnetic layer in the range of 0.05 μm to 2.0 μm, and preferably 0.07 to 1 μm. When a lower layer (a non-magnetic layer) is provided, the dry thickness of the lower layer is preferably 0.2 to 3.0 μm, more preferably 0.3 to 2.5 μm, and yet more preferably 0.4 to 2.0 μm. A plurality of magnetic layer coating solutions can be applied successively or simultaneously in multilayer coating, and a lower layer coating solution and a magnetic layer coating solution can also be applied successively or simultaneously in multilayer coating. As coating equipment for applying the above-mentioned magnetic coating solution or lower layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used.

With regard to these, for example, ‘Saishin Kotingu Gijutsu’ (Latest Coating Technology) (May 31, 1983) published by Sogo Gijutsu Center can be referred to.

When the present invention is applied to a magnetic recording medium having an arrangement in which there is a lower layer (non-magnetic layer or magnetic layer), as examples of the coating equipment and the coating method, the following can be proposed.

(1) A lower layer is firstly applied by coating equipment such as gravure, roll, blade, or extrusion coating equipment, which is generally used for coating with a magnetic layer coating solution, and before the lower layer has dried an upper layer is applied by a pressurized support type extrusion coating device such as one disclosed in JP-B-1-46186, JP-A-60-238179, or JP-A-2-265672 (JP-B denotes a Japanese examined patent application publication).

(2) Upper and lower layers are substantially simultaneously applied by means of one coating head having two slits for a coating solution to pass through, such as one disclosed in JP-A-63-88080, JP-A-2-17971, or JP-A-2-265672.

(3) Upper and lower layers are substantially simultaneously applied by means of an extrusion coating device with a backup roll, such as one disclosed in JP-A-2-174965.

The surface of the support used in the present invention that has not been coated with the magnetic coating solution may be provided with a back layer. The back layer is a layer provided by coating the surface of the support that has not been coated with the magnetic coating solution with a back layer-forming coating solution in which a particulate component such as an abrasive or an antistatic agent and a binder are dispersed in an organic solvent. As the particulate component, various types of inorganic pigment or carbon black can be used, and as the binder, a resin such as nitrocellulose, a phenoxy resin, a vinyl chloride resin, or a polyurethane can be used singly or in combination. In addition, an undercoat layer for improving the adhesion or a known undercoat layer may be provided on the surface of the support that is to be coated with the back layer coating solution.

The coated layer of the magnetic layer coating solution is dried after subjecting the ferromagnetic powder contained in the coated layer of the magnetic layer coating solution to a magnetic field alignment treatment. After drying is carried out in this way, the coated layer may be subjected to a surface smoothing treatment. The surface smoothing treatment may employ, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained. With regard to calendering rolls, rolls of a heat-resistant plastic such as epoxy, polyimide, polyamide, or polyamideimide may be used. It is also possible to carry out treatment with metal rolls.

It is preferable for the magnetic recording medium of the present invention, as a high density recording magnetic recording medium, to have a surface that has a center line average roughness in the range of 0.1 to 5 nm, and preferably 1 to 4 nm for a cutoff value of 0.25 mm, which is extremely smooth. As a method therefor, a magnetic layer formed by selecting a specific ferromagnetic powder and binder as described above is subjected to the above-mentioned calendering treatment. With regard to calendering conditions, the calender roll temperature is preferably in the range of 60° C. to 100° C., more preferably in the range of 70° C. to 100° C., and yet more preferably in the range of 80° C. to 100° C., and the calender roll pressure is preferably in the range of 100 to 500 kg/cm (98 to 490 kN/m), more preferably in the range of 200 to 450 kg/cm (196 to 441 kN/m), and yet more preferably in the range of 300 to 400 kg/cm (294 to 392 kN/m). The magnetic recording medium thus obtained can be cut to a desired size using a cutter, etc. before use.

In accordance with the present invention, there is provided a magnetic recording medium having improved sliding durability after being stored in a high temperature, high humidity environment, improved adhesion and electromagnetic conversion characteristics, and little hygroscopic expansion.

### EXAMPLES

The present invention is explained more specifically below by reference to Examples, but the present invention should not be construed as being limited thereby.

‘Parts’ in the Examples means ‘parts by weight’ unless otherwise specified.

Synthetic Example of Radiation Curing Compound (Urethane Acrylate)

In a container equipped with a reflux condenser and a stirrer and flushed with nitrogen in advance, 1 mol of the diisocyanate, terminal isocyanate urethane oligomer, or terminal OH urethane oligomer shown in Table 1 was dissolved in methyl ethyl ketone (MEK) under a flow of nitrogen at 60° C. to give a 30% solution. Subsequently, as a catalyst, dibutyltin dilaurate was added thereto at 60 ppm and dissolved for a further 5 minutes. 2 mol of the acrylate compound shown in Table 1 was further added thereto, and a reaction was carried out while heating at 60° C. for 6 hours to give a solution of urethane acrylates A to P.

The solution thus obtained was subjected to FTIR, and it was confirmed that there was no peak at around 2250 cm⁻¹ attributable to an NCO group and there was no change in a peak at around 1410 cm⁻¹ attributable to an acryloyl group.

Table 1 shows compounds used for the synthesis of urethane acrylate solutions A to P.

TABLE 1

| Urethane | | Terminal NCO | Terminal OH | Acrylate |
|---|---|---|---|---|
| acrylate | Diisocyanate | urethane oligomer | urethane oligomer | compound |
| A | Hydrogenated | | | HEA |
| | MDI | | | |
| B | Hydrogenated | | | Compound A |
| | MDI | | | |
| C | Hydrogenated | | | HEMA |
| | MDI | | | |
| D | | Hexanediol/ | | HEA |
| | | hydrogenated MDI = 1/2 mol | | |
| | | reaction | | |
| | | product | | |
| E | | Hexanediol/ | | HEMA |
| | | hydrogenated MDI = 1/2 mol | | |
| | | reaction | | |
| | | product | | |
| F | | Hexanediol/ | | PE3A |
| | | hydrogenated MDI = 1/2 mol | | |
| | | reaction | | |
| | | product | | |
| G | | | Hexanediol/ | MOA |
| | | | hydrogenated MDI = 2/1 mol | |
| | | | reaction | |
| | | | product | |
| H | | | Hexanediol/ | MOI |
| | | | hydrogenated MDI = 2/1 mol | |
| | | | reaction | |
| | | | product | |
| I | MDI | | | MEA |
| J | MDI | | | Compound A |
| K | MDI | | | HEMA |
| L | | Hexanediol/MDI = 1/2 mol | | HEA |
| | | reaction | | |
| | | product | | |
| M | | Hexanediol/MDI = 1/2 mol | | HEMA |
| | | reaction | | |
| | | product | | |
| N | | Hexanediol/MDI = 1/2 mol | | PE3A |
| | | reaction | | |
| | | product | | |
| O | | | Hexanediol/MDI = 2/1 mol | MOA |
| | | | reaction | |
| | | | product | |
| P | | | Hexanediol/MDI = 2/1 mol | MOI |
| | | | reaction | |
| | | | product | |

The chemical structures of the compounds used for the synthesis of the urethane acrylates A to P are shown below.
Hydrogenated MDI: hydrogenated diphenylmethane diisocyanate 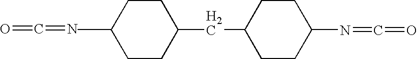
MDI: diphenylmethane diisocyanate 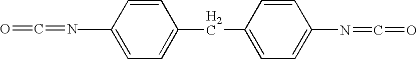
HEA: hydroxyethyl acrylate 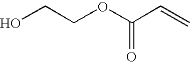
HEMA: hydroxyethyl methacrylate 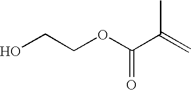
Compound A: lactone-modified acrylate 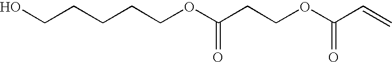
MOA: acryloyloxyethyl isocyanate 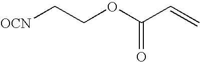
MOI: methacryloyloxyethyl isocyanate 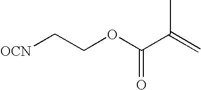
PE3A: pentaerythritol triacrylate

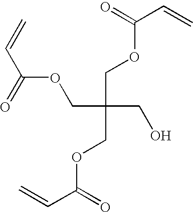

### Example 1

Preparation of Magnetic Layer Coating Solution

100 parts of an acicular ferromagnetic alloy powder (composition: Fe 89 atm %, Co 5 atm %, Y 6 atm %; Hc 175 kA/m (2,200 Oe); BET surface area 70 m²/g; major axis length 35 nm; acicular ratio 3; σs 125 A·m²/kg (emu/g)) was ground in an open kneader for 10 minutes, and then kneaded for 60 minutes with 10 parts (solids content) of an SO₃Na-containing polyurethane solution (solids content 30%; SO₃Na content 150 μeq/g; weight-average molecular weight 80,000) and 30 parts of cyclohexanone.

Subsequently,

| | |
|---|---|
| an abrasive (Al₂O₃, particle size 0.15 μm) | 2 parts |
| carbon black (particle size 20 μm) | 2 parts, and |
| methyl ethyl ketone/toluene = 1/1 | 200 parts |

were added, and the mixture was dispersed in a sand mill for 120 minutes. To this were added

| | |
|---|---|
| butyl stearate | 2 parts |
| stearic acid | 1 part, and |
| methyl ethyl ketone (MEK) | 50 parts, |

and after stirring the mixture for a further 20 minutes, it was filtered using a filter having an average pore size of 1 μm to give a magnetic coating solution.
Preparation of Non-Magnetic Layer Coating Solution

100 parts of α-Fe₂O₃ (average particle size 0.15 μm; S_{BET} 52 m²/g; surface treatment with Al₂O₃ and SiO₂; pH 6.5 to 8.0) was ground in an open kneader for 10 minutes, and then kneaded for 60 minutes with 15 parts (solids content) of an SO₃Na-containing polyurethane solution (solids content 30%; SO₃Na content 70 μeq/g; weight-average molecular weight 80,000) and 30 parts of cyclohexanone.

Subsequently,

methyl ethyl ketone/cyclohexanone= 6/4200 parts was added, and the mixture was dispersed in a sand mill for 120 minutes. To this were added

| | |
|---|---|
| butyl stearate | 2 parts |
| stearic acid | 1 part, and |
| methyl ethyl ketone | 50 parts, |

and after stirring the mixture for a further 20 minutes, it was filtered using a filter having an average pore size of 1 μm to give a non-magnetic layer coating solution.

As the radiation curing compound for the radiation-cured layer, the urethane acrylate A shown in Table 1 was made into a 15 wt % solution (MEK diluted solution), and the surface of a 7 μm thick polyethylene terephthalate support having a center average surface roughness Ra of 6.2 nm was coated by means of a wire-wound bar with this urethane acrylate A solution so that the dry thickness would be 0.5 μm. After drying, the coated surface was cured by irradiation with an electron beam at an acceleration voltage of 125 kV so as to give an absorbed dose of 3 Mrad.

Subsequently, using reverse roll simultaneous multilayer coating, the non-magnetic coating solution and then the magnetic coating solution on top thereof were applied to the radiation-cured layer so that the dry thickness would be 1.0 μm and 0.1 μm respectively. Before the magnetic coating solution had dried, it was subjected to magnetic field alignment using a 5,000 G Co magnet and a 4,000 G solenoid magnet, the solvent was dried off, and the coating was then subjected to a calender treatment employing a metal roll-metal roll-metal roll-metal roll-metal roll-metal roll-metal roll combination (speed 100 m/min, line pressure 300 kg/cm, temperature 90° C.) and then slit to a width of ½inch to give a magnetic tape.

### Examples 2 to 8, Comparative Examples 1 to 8

Magnetic tapes were prepared in the same manner as in Example 1 except that the radiation curing compound A for the radiation-cured layer was changed to those shown in Table 2.

Measurement Method

(1) Adhesion

A tape was aged in an environment at 23° C. and 50% for 1 hour, double-sided tape was then affixed to the magnetic layer surface and peeled off at a speed of 14 mm/sec at an angle of 180°, and the peel strength was measured using a spring scale.

(2) Durability After Storage

A tape was stored in an environment at 60° C. and 90% RH for 30 days while wound in a reel, the magnetic layer surface was made to slide under the conditions below, and damage to the magnetic layer surface after sliding was examined and evaluated using the rankings below.

Sliding Conditions

The magnetic layer surface was made to slide repeatedly for 10,000 passes at 2,000 mm/sec in an environment of 23° C. and 80% RH while in contact with an SUS420 member with a load of 50 g.

Damage to Magnetic Layer Surface After Sliding

The magnetic layer surface after sliding was examined visually using a differential interference microscope (magnification 50).

Evaluation Rankings

Excellent: no damage to the magnetic layer surface after sliding, and similar to the surface before sliding.

Good: scraping off observed on the magnetic layer surface after sliding, but sliding was possible for 10,000 passes.

Poor: stuck to the SUS member and stopped before 10,000 passes.

(3) Coefficient of Hygroscopic Expansion

A sample of 30 mm in the width direction and 5 mm in the longitudinal direction was cut out of a tape, and this was set in a TMA system and aged at 30° C. and 30% RH for 24 hours. After the aging, changes in the dimensions at humidities of 30% to 80% RH were measured in the MD direction and in the TD direction, and the coefficient of hygroscopic expansion was determined using the equation below.

$$Coefficient of hygroscopic expansion = \frac{\frac{length of magnetic recording medium at {T}_{4} - length of magnetic recording medium at {T}_{3}}{length of magnetic recording medium at {T}_{3}}}{change in humidity ( {T}_{4} - {T}_{3} )}$$

In the equation, T₃ denotes the % RH before the measurement and T₄ denotes the % RH after the measurement.

The MD direction is the longitudinal direction of the magnetic recording medium, and the TD direction is the width direction of the magnetic recording medium.

The coefficient of hygroscopic expansion is expressed using units of ppm/% RH.

(4) Electromagnetic Conversion Characteristics

Measurement was carried out by mounting a recording head (MIG gap 0.15 μm, 1.8 T) and an MR playback head on a drum tester.

The playback output was measured at a speed of the medium relative to the head of 1 to 3 m/min and a surface recording density of 0.57 Gbit/(inch)² and expressed as a relative value where the playback output of Comparative Example 1 was 0 dB.

The type of radiation curing compound used for the formation of magnetic tapes and the measurement results are shown in Table 2.

TABLE 2

| | | | | Coefficient | | Electro- |
|---|---|---|---|---|---|---|
| | | | | of | | magnetic |
| | | | | hygroscopic | | conversion |
| | | | Durability | expansion | | char- |
| | Urethane | Adhesion | after | (ppm) | | acteristics |
| | acrylate | (gf) | storage | MD | TD | (dB) |
| Ex. 1 | A | ≧300 | Excellent | 9 | 7 | 0.9 |
| Ex. 2 | B | ≧300 | Excellent | 6 | 9 | 1.2 |
| Ex. 3 | C | ≧300 | Excellent | 6 | 9 | 1.1 |
| Ex. 4 | D | ≧300 | Excellent | 7 | 8 | 1.2 |
| Ex. 5 | E | ≧300 | Excellent | 7 | 8 | 1 |
| Ex. 6 | F | ≧300 | Excellent | 8 | 8 | 0.7 |
| Ex. 7 | G | ≧300 | Excellent | 9 | 7 | 1 |
| Ex. 8 | H | ≧300 | Excellent | 6 | 7 | 0.9 |
| Comp. | I | 78 | Poor | 21 | 19 | 0 |
| Ex. 1 | | | | | | |
| Comp. | J | 92 | Poor | 19 | 21 | 0 |
| Ex. 2 | | | | | | |
| Comp. | K | 102 | Poor | 18 | 19 | 0.1 |
| Ex. 3 | | | | | | |
| Comp. | L | 123 | Poor | 17 | 15 | 0.3 |
| Ex. 4 | | | | | | |
| Comp. | M | 118 | Poor | 16 | 14 | 0.2 |
| Ex. 5 | | | | | | |
| Comp. | N | 132 | Good | 19 | 21 | −0.1 |
| Ex. 6 | | | | | | |
| Comp. | O | 118 | Good | 18 | 22 | 0 |
| Ex. 7 | | | | | | |
| Comp. | P | 53 | Good | 25 | 28 | −1.2 |
| Ex. 8 | | | | | | |

What is claimed is:

1. A magnetic recording medium comprising:
a non-magnetic support and, above the support;
a radiation-cured layer cured by exposing a layer comprising a radiation curing compound to radiation; and
at least one magnetic layer comprising a ferromagnetic powder dispersed in a binder;
the radiation curing compound comprising a urethane (meth)acrylate obtained from a compound having two or more cyclohexane rings per molecule.

2. The magnetic recording medium according to claim 1, wherein the magnetic recording medium comprises, between the radiation-cured layer and the magnetic layer, a non-magnetic layer comprising a non-magnetic powder dispersed in a binder.

3. The magnetic recording medium according to claim 1, wherein the compound having two or more cyclohexane rings per molecule is a hydrogenated diphenylmethane diisocyanate.

4. The magnetic recording medium according to claim 1, wherein the urethane (meth)acrylate is a compound obtained by reacting a diisocyanate compound, a diol compound, a urethane oligomer having a terminal isocyanate group, or a urethane oligomer having a terminal hydroxyl group, these having two or more cyclohexane rings, with a compound having both a radiation curing functional group and a group that reacts with an isocyanate group or a hydroxyl group.

5. The magnetic recording medium according to claim 1, wherein the compound having two or more cyclohexane rings per molecule is a compound having at least one of the frameworks shown below.

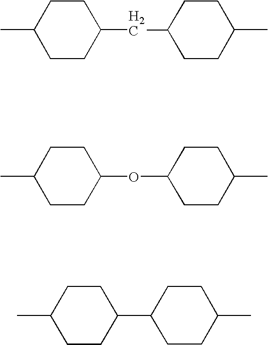

6. The magnetic recording medium according to claim 1, wherein the compound having two or more cyclohexane rings per molecule has 2 to 5 cyclohexane rings.

7. The magnetic recording medium according to claim 1, wherein the compound having two or more cyclohexane rings per molecule has 2 cyclohexane rings.

8. The magnetic recording medium according to claim 1, wherein the radiation curing compound has as a radiation curing functional group an acryloyl group or a methacryloyl group.

9. The magnetic recording medium according to Claim 1, wherein the radiation curing compound has as a radiation curing functional group an acryloyl group.

10. The magnetic recording medium according to claim 1, wherein the urethane (meth)acrylate has 2 to 10 radiation curing functional groups per molecule.

11. The magnetic recording medium according to claim 1, wherein the urethane (meth)acrylate has 2 to 6 radiation curing functional groups per molecule.

12. The magnetic recording medium according to claim 1, wherein the magnetic recording medium has a coefficient of hygroscopic expansion expressed by the equation below of 0 to 15 ppm/% RH:
$$Coefficient of hygroscopic expansion = \frac{\frac{length of magnetic recording medium at {T}_{4} - length of magnetic recording medium at {T}_{3}}{length of magnetic recording medium at {T}_{3}}}{change in humidity ( {T}_{4} - {T}_{3} )}$$
wherein T₃ denotes the % RH at the beginning of the measurement and T₄ denotes the % RH at the end of the measurement.

13. The magnetic recording medium according to claim 1, wherein the radiation-cured layer has a thickness of 0.1 to 1.0 μm.

14. The magnetic recording medium according to claim 1, wherein the magnetic layer has a thickness of 0.07 to 1 μm.

15. The magnetic recording medium according to claim 2, wherein the non-magnetic layer has a thickness of 0.4 to 2.0 μm.
